(19) United States
(12) Patent Application Publication
(10) Pub. No.: US 2025/0338311 A1
(43) Pub. Date: Oct. 30, 2025

(54) APPARATUS, SYSTEM, AND METHOD OF LOW LATENCY TRAFFIC

(71) Applicant: INTEL CORPORATION, Santa Clara, CA (US)

(72) Inventors: Laurent Cariou, Milizac (FR); Thomas Kenney, Portland, OR (US)

(73) Assignee: INTEL CORPORATION, Santa Clara, CA (US)

(21) Appl. No.: 19/257,950

(22) Filed: Jul. 2, 2025

Related U.S. Application Data
(60) Provisional application No. 63/668,075, filed on Jul. 5, 2024.
(60) Provisional application No. 63/707,562, filed on Oct. 15, 2024.

(51) Int. Cl. H04W 74/0808

(52) U.S. Cl. CPC H04W 74/0808

(57) ABSTRACT

For example, an Access Point (AP) may be configured to set a predefined indication field to a predefined setting configured to indicate a request for a non-AP station (STA) to provide a current Enhanced Distributed Channel Access (EDCA) retry count for one or more low latency traffic flows. For example, the AP may be configured to transmit a Buffer Status Report Poll (BSRP) trigger frame to solicit a Buffer Status Report (BSR) from the non-AP STA. For example, the BSRP trigger frame may be configured to include the predefined indication field. For example, the non-AP STA may be configured to process the BSRP trigger frame, and to transmit to the AP a frame including a reported current EDCA retry count corresponding to a reported low latency traffic flow, for example, based on a determination that the predefined indication field is set to the predefined setting.

### CROSS REFERENCE

This application claims the benefit of and priority from U.S. Provisional Patent Application No. 63/668,075 entitled “BUFFER STATUS REPORT POLL FOR LOW LATENCY TRAFFIC”, filed Jul. 5, 2024, and from U.S. Provisional Patent Application No. 63/707,562 entitled “MULTI-USER ENHANCED DISTRIBUTED CHANNEL ACCESS AND LOW LATENCY TRAFFIC”, filed Oct. 15, 2024, the entire disclosures of which are incorporated herein by reference.

### BACKGROUND

Devices in a wireless communication system may be configured to communicate various types of frames, which may include, for example, beacon frames, data frames, control frames, or the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic flow-chart illustration of a method of low latency traffic, in accordance with some demonstrative aspects.

FIG. 3 is a schematic flow-chart illustration of a method of low latency traffic, in accordance with some demonstrative aspects.

FIG. 4 is a schematic flow-chart illustration of a method of low latency traffic, in accordance with some demonstrative aspects.

FIG. 5 is a schematic flow-chart illustration of a method of low latency traffic, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology Telecommunications and Information Exchange between Systems Local and Metropolitan Area Networks-Specific Requirements; Part 11: Wireless LAN Medium Access Control (MAC) and Physical Layer (PHY) Specifications, December 2020); IEEE 802.11ax (IEEE 802.11ax-2021, IEEE Standard for Information Technology-Telecommunications and Information Exchange between Systems Local and Metropolitan Area Networks-Specific Requirements; Part 11: Wireless LAN Medium

Access Control (MAC) and Physical Layer (PHY) Specifications; Amendment 1: Enhancements for High-Efficiency WLAN, Feb. 9, 2021); and/or IEEE 802.11bn (IEEE P802.11bn/D0.3 Draft Standard for Information technology-Telecommunications and information exchange between systems Local and metropolitan area networks-Specific requirements; Part 11: Wireless LAN Medium Access Control (MAC) and Physical Layer (PHY) Specifications; Amendment 6: Enhancements for ultra-high reliability (UHR), May 2025)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division n Multiple Access (OFDMA), Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stack, buffers, and/or the like, coupled to the one or more processors, e.g., as necessary to execute the logic.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink (UL) frames using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHZ, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

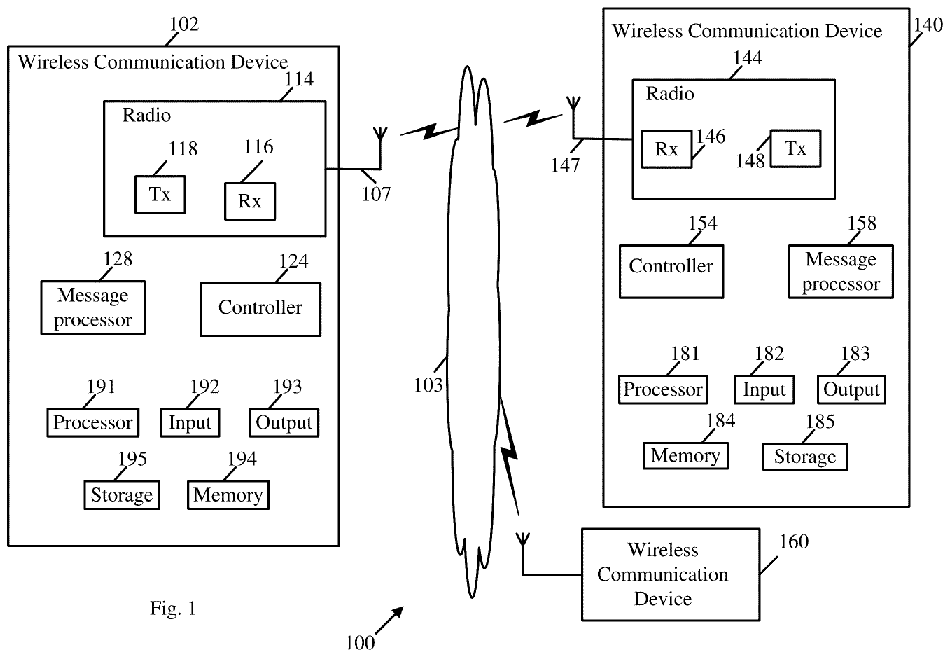

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mm Wave band, a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a Wi-Fi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11ax Specification, an IEEE 802.11bn Specification, and/or any other specification and/or protocol.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may include, operate as, perform a role of, and/or perform the functionality of, one or more AP STAs and/or one or more non-AP STAs. In one example, device 102 may include, operate as, perform a role of, and/or perform the functionality of, at least one AP STA, and/or device 140 may include, operate as, perform a role of, and/or perform the functionality of, at least one non-AP STA.

In some demonstrative aspects, device 102 may include, operate as, perform a role of, and/or perform the functionality of, a first STA, e.g., an AP STA or a non-AP STA.

In some demonstrative aspects, device 140 may include, operate as, perform a role of, and/or perform the functionality of, a second STA, e.g., an AP STA or a non-AP STA.

In some demonstrative aspects, device 160 may include, operate as, perform a role of, and/or perform the functionality of, a third STA, e.g., an AP STA or a non-AP STA.

In other aspects, device 102, device 140, and/or device 160 may include, operate as, perform a role of, and/or perform the functionality of any other additional or alternative type of STA.

In some demonstrative aspects, device 102, device 140, and/or device 160 may be configured to implement one or more operations and/or functionalities of one or more low latency traffic communication mechanisms, which may be configured to support communication of low latency traffic flows, e.g., as described below.

In some demonstrative aspects, device 102, device 140, and/or device 160 may be configured to implement one or more operations and/or functionalities of one or more low latency traffic communication mechanisms, which may be configured to support communication of low latency Uplink (UL) traffic flows from a non-AP STA to an AP, e.g., as described below.

In some demonstrative aspects, device 102, device 140, and/or device 160 may be configured to implement one or more operations and/or functionalities of a Buffer Status Report (BSR) mechanism, which may be configured to support low latency traffic, e.g., as described below.

In some demonstrative aspects, device 102, device 140, and/or device 160 may be configured to implement one or more operations and/or functionalities of a BSR mechanism, which may be configured to provide a technical solution to support sharing a buffer status from one or more non-AP STAs with an AP, e.g., as described below.

For example, a Quality of Service (QOS) Null or a QoS Data frame may be configured to include a status for one or more Traffic Identifiers (TIDs).

In one example, a QoS Control field may be used by a non-AP STA to convey a buffer status to an AP, e.g., according to a first signaling mechanism.

In another example, an HT Control field may be used by a non-AP STA to convey a buffer status to an AP, e.g., according to a second signaling mechanism.

In some demonstrative aspects, a non-AP STA may be configured to provide a buffer status to an AP in an unsolicited manner, for example, when the non-AP STA desires. For example, the non-AP STA may provide the buffer status to the AP along with data frames the non-AP STA is sending to the AP.

For example, the AP may request the non-AP STA to send the buffer status of the non-AP STA.

For example, the AP may collect buffer statuses from multiple non-AP STAs at the same time.

For example, the AP may send a trigger frame, e.g., a Buffer Status Report Poll (BSRP) trigger frame, which may be configured to poll one or more non-AP STAs for a buffer status report.

In some demonstrative aspects, device 102, device 140, and/or device 160 may be configured to implement one or more operations and/or functionalities of a BSR mechanism, which may be configured to support low latency traffic communication, e.g., as described below.

In some demonstrative aspects, device 102, device 140, and/or device 160 may be configured to implement one or more operations and/or functionalities of a BSR mechanism, which may be configured to provide a technical solution to support one or more non-AP STAs in reducing their tail latency, for example, to reduce large delay edge cases, e.g., as described below.

For example, non-AP STAs may operate with an Enhanced Distributed Channel Access (EDCA) for their channel access, e.g., with respect to the vast majority of traffic.

For example, a non-AP STA may suffer from a tail latency, for example, when the non-AP STA has to retransmit multiple times after an initial failed transmission. For example, the non-AP STA may be required to increase, e.g., double, the backoff every retransmission, e.g., due to EDCA rules.

In some demonstrative aspects, device 102, device 140, and/or device 160 may be configured to implement one or more operations and/or functionalities of a BSR mechanism, which may be configured to support signaling of EDCA retry information from one or more non-AP STAs to an AP, e.g., as described below.

In some demonstrative aspects, the BSR mechanism may be configured to provide a technical solution to support an AP to schedule communications for one or more non-AP STAs, for example, based on the EDCA retry information received from the non-AP STAs, e.g., as described below.

In some demonstrative aspects, the BSR mechanism may be configured to utilize a BSRP trigger frame, which may be configured to provide a technical solution to support an AP in indicating to a non-AP STA a request for EDCA retry information, e.g., as described below.

In some demonstrative aspects, the BSRP trigger frame may include a field, which may be configured to indicate that a request for BSR feedback includes a request that the BSR feedback is to include information about a current EDCA retry count of a non-AP STA having low latency traffic.

In some demonstrative aspects, a non-AP STA may be considered as a non-AP STA having low latency traffic (“low latency non-AP STA”), for example, when the non-AP STA has one or more TIDs (“low latency TIDs”) corresponding to one or more low latency traffic flows.

In some demonstrative aspects, the BSR mechanism may be configured to provide a technical solution for a non-AP STA to report to an AP about EDCA retry information corresponding to one or more low latency traffic flows of the non-AP STA, e.g., as described below.

In some demonstrative aspects, the BSR mechanism may be configured to provide a technical solution to support a non-AP STA in signaling a low latency mode at which the non-AP STA is to transmit to the AP uplink transmissions of one or more low-latency traffic flows, e.g., as described below.

In some demonstrative aspects, the BSR mechanism may be configured to provide a technical solution to support a non-AP STA in signaling a periodicity of low latency transmissions, e.g., as described below.

In some demonstrative aspects, controller 124 may be configured to control, trigger, cause, and/or instruct an AP implemented by device 102 to set a predefined indication field in a BSRP trigger frame, e.g., as described below.

In some demonstrative aspects, controller 124 may be configured to control, trigger, cause, and/or instruct the AP implemented by device 102 to set the predefined indication field to a predefined setting configured to indicate a request for a non-AP STA, for example, to provide a current EDCA retry count for one or more low latency traffic flows, e.g., as described below.

In some demonstrative aspects, controller 124 may be configured to control, trigger, cause, and/or instruct the AP implemented by device 102 to transmit the BSRP trigger frame, for example, to solicit a BSR from the non-AP STA, e.g., as described below.

In some demonstrative aspects, the BSRP trigger frame may be configured to include the predefined indication field, e.g., as described below.

In other aspects, the BSRP trigger frame may include any other additional or alternative fields.

In some demonstrative aspects, controller 124 may be configured to control, trigger, cause, and/or instruct the AP implemented by device 102 to set a single bit in the predefined indication field to a predefined value, for example, to indicate the request for the non-AP to provide the current EDCA retry count for the one or more low latency traffic flows, e.g., as described below.

In some demonstrative aspects, the predefined value may be one.

In other aspects, the predefined value may include any other predetermined value.

In some demonstrative aspects, controller 124 may be configured to control, trigger, cause, and/or instruct the AP implemented by device 102 to set identification information in the predefined indication field, e.g., as described below.

In some demonstrative aspects, the identification information may be configured to identify at least one low latency traffic flow, e.g., as described below.

In some demonstrative aspects, the identification information may include a low latency Traffic Identifier (TID) corresponding to the at least one low latency traffic flow, e.g., as described below.

In some demonstrative aspects, the identification information may include a Stream Classification Service Identifier (SCSID) corresponding to the at least one low latency traffic flow, e.g., as described below.

In other aspects, the identification information may include any other additional or alternative information to identify at least one low latency traffic flow.

In some demonstrative aspects, the predefined indication field may include a low latency reporting field in the BSRP trigger frame, e.g., as described below.

In some demonstrative aspects, controller 124 may be configured to control, trigger, cause, and/or instruct the AP implemented by device 102 to process a received frame from the non-AP STA, for example, to identify a reported low latency traffic flow, a solicited BSR corresponding to the reported low latency traffic flow, and/or a reported current EDCA retry count corresponding to the reported low latency traffic flow, e.g., as described below.

In some demonstrative aspects, controller 124 may be configured to control, trigger, cause, and/or instruct the AP implemented by device 102 to allocate UL resources for the non-AP STA, for example, based on the reported current EDCA retry count, e.g., as described below.

In some demonstrative aspects, controller 124 may be configured to control, trigger, cause, and/or instruct the AP implemented by device 102 to transmit a trigger frame to trigger an UL transmission from the non-AP STA, for example, according to the UL resources allocated for the non-AP STA, e.g., as described below.

In some demonstrative aspects, controller 124 may be configured to control, trigger, cause, and/or instruct the AP implemented by device 102 to transmit a Multi-User (MU) Request to Send (RTS) (MU-RTS) frame to configure a time allocation for the non-AP STA, for example, according to the UL resources allocated for the non-AP STA, e.g., as described below.

In some demonstrative aspects, the reported current EDCA retry count may include a current EDCA retry count value for an Access Category (AC) to which the low latency traffic flow is mapped, e.g., as described below.

In some demonstrative aspects, controller 124 may be configured to control, trigger, cause, and/or instruct the AP implemented by device 102 to identify the reported low latency traffic flow, for example, based on a low latency TID in the received frame, e.g., as described below.

In some demonstrative aspects, controller 124 may be configured to control, trigger, cause, and/or instruct the AP implemented by device 102 to identify the reported low latency traffic flow, for example, based on a SCSID in the received frame, e.g., as described below.

In other aspects, controller 124 may be configured to control, trigger, cause, and/or instruct the AP implemented by device 102 to identify the reported low latency traffic flow based on any other additional or alternative identification information in the received frame.

In some demonstrative aspects, controller 124 may be configured to control, trigger, cause, and/or instruct the AP implemented by device 102 to transmit a management frame configured to advertise that the AP is to schedule transmission of low latency BSRP trigger frames, for example, according to a set periodicity, e.g., as described below.

In some demonstrative aspects, controller 124 may be configured to control, trigger, cause, and/or instruct the AP implemented by device 102 to transmit the low latency BSRP trigger frames including the predefined indication field set to the predefined setting to indicate the request to provide the current EDCA retry count, e.g., as described below.

In some demonstrative aspects, controller 124 may be configured to control, trigger, cause, and/or instruct the AP implemented by device 102 to transmit a management frame, which may be configured to indicate a duration of a BSRP period, e.g., as described below.

In some demonstrative aspects, the BSRP period may include a time period between two consecutive low latency BSRP trigger frames including the predefined indication field set to the predefined setting to indicate the request to provide the current EDCA retry count, e.g., as described below.

In some demonstrative aspects, controller 124 may be configured to control, trigger, cause, and/or instruct the AP implemented by device 102 to transmit a broadcast Target Wake Time (TWT) element, which may be configured, for example, to advertise a broadcast TWT for one or more low latency non-AP STAs, e.g., as described below.

In some demonstrative aspects, the one or more low latency non-AP STAs may include the non-AP STA, e.g., as described below.

In some demonstrative aspects, controller 124 may be configured to control, trigger, cause, and/or instruct the AP implemented by device 102 to transmit the BSRP trigger frame including the predefined indication field set to the predefined setting to indicate the request to provide the current EDCA retry count, for example, during a broadcast TWT Service Period (SP) of the broadcast TWT, e.g., as described below.

In some demonstrative aspects, controller 124 may be configured to control, trigger, cause, and/or instruct the AP implemented by device 102 to transmit the BSRP trigger frame including the predefined indication field set to the predefined setting to indicate the request to provide the current EDCA retry count, for example, at a beginning of each broadcast TWT SP of the broadcast TWT, e.g., as described below.

In some demonstrative aspects, controller 124 may be configured to control, trigger, cause, and/or instruct the AP implemented by device 102 to set a predefined value in a broadcast TWT recommendation field of the broadcast TWT element, for example, to advertise the broadcast TWT for the one or more low latency non-AP STAs, e.g., as described below.

In some demonstrative aspects, the predefined value in the broadcast TWT recommendation field, which may be utilized to advertise the broadcast TWT for the one or more low latency non-AP STAs, may be 5.

In other aspects, any other predefined value in the broadcast TWT recommendation field may be defined to advertise the broadcast TWT for the one or more low latency non-AP STAs.

In some demonstrative aspects, controller 124 may be configured to control, trigger, cause, and/or instruct the AP implemented by device 102 to transmit low latency mode information including a low latency mode enablement indication, for example, to indicate enablement of a low latency mode at which the AP is to transmit low latency BSRP trigger frames including the predefined indication field set to the predefined setting to indicate the request to provide the current EDCA retry count, e.g., as described below.

In some demonstrative aspects, controller 124 may be configured to control, trigger, cause, and/or instruct the AP implemented by device 102 to configure the low latency mode information including a low latency mode duration indication, for example, to indicate a time period during which the low latency mode is to be enabled, e.g., as described below.

In some demonstrative aspects, controller 124 may be configured to control, trigger, cause, and/or instruct the AP implemented by device 102 to transmit a low latency mode disablement indication, which may be configured, for example, to indicate disablement of the low latency mode, e.g., as described below.

In some demonstrative aspects, controller 154 may be configured to control, trigger, cause, and/or instruct a non-AP STA implemented by device 140 to process a BSRP trigger frame from an AP, for example, to identify whether a predefined indication field is set to a predefined setting configured to indicate a request to provide a current EDCA retry count for one or more low latency traffic flows, e.g., as described below.

For example, controller 154 may be configured to control, trigger, cause, and/or instruct the non-AP STA implemented by device 140 to process the BSRP trigger frame transmitted by the AP implemented by device 102, e.g., as described above.

In some demonstrative aspects, controller 154 may be configured to control, trigger, cause, and/or instruct the non-AP STA implemented by device 140 to transmit to the AP a frame including an indication of a reported low latency traffic flow, a solicited BSR corresponding to the reported low latency traffic flow, and/or a reported current EDCA retry count corresponding to the reported low latency traffic flow, for example, based on a determination that the predefined indication field is set to the predefined setting to indicate the request to provide the current EDCA retry count, e.g., as described below.

In some demonstrative aspects, controller 154 may be configured to control, trigger, cause, and/or instruct the non-AP STA implemented by device 140 to determine that the predefined indication field is set to the predefined setting to indicate the request to provide the current EDCA retry count, for example, based on a determination that a single bit in the predefined indication field is set to a predefined value, e.g., as described below.

In some demonstrative aspects, controller 154 may be configured to control, trigger, cause, and/or instruct the non-AP STA implemented by device 140 to determine that the predefined indication field is set to the predefined setting to indicate the request to provide the current EDCA retry count, for example, based on a determination that the single bit in the predefined indication field is set to one (“1”), e.g., as described below.

In other aspects, the predefined indication field may be set to any other predetermined value to indicate the request to provide the current EDCA retry count.

In some demonstrative aspects, controller 154 may be configured to control, trigger, cause, and/or instruct the non-AP STA implemented by device 140 to process identification information in the predefined indication field, for example, to identify at least one low latency traffic flow, e.g., as described below.

In some demonstrative aspects, controller 154 may be configured to control, trigger, cause, and/or instruct the non-AP STA implemented by device 140 to process the identification information including a low latency TID corresponding to the at least one low latency traffic flow, e.g., as described below.

In some demonstrative aspects, controller 154 may be configured to control, trigger, cause, and/or instruct the non-AP STA implemented by device 140 to process the identification information including an SCSID corresponding to the at least one low latency traffic flow, e.g., as described below.

In some demonstrative aspects, the predefined indication field may be configured to include a low latency reporting field in the BSRP trigger frame, e.g., as described below.

In some demonstrative aspects, controller 154 may be configured to control, trigger, cause, and/or instruct the non-AP STA implemented by device 140 to set the reported current EDCA retry count including a current EDCA retry count value for an AC to which the low latency traffic flow is mapped, e.g., as described below.

In some demonstrative aspects, controller 154 may be configured to control, trigger, cause, and/or instruct the non-AP STA implemented by device 140 to set a low latency TID in the frame to identify the reported low latency traffic flow, e.g., as described below.

In some demonstrative aspects, controller 154 may be configured to control, trigger, cause, and/or instruct the non-AP STA implemented by device 140 to set a low latency SCSID in the frame to identify the reported low latency traffic flow, e.g., as described below.

In some demonstrative aspects, controller 154 may be configured to control, trigger, cause, and/or instruct the non-AP STA implemented by device 140 to process a management frame from the AP, for example, to identify an indication that the AP is to schedule transmission of low latency BSRP trigger frames, for example, according to a set periodicity, e.g., as described below.

In some demonstrative aspects, the low latency BSRP trigger frames may be configured to include the predefined indication field set to the predefined setting to indicate the request to provide the current EDCA retry count, e.g., as described below.

In some demonstrative aspects, controller 154 may be configured to control, trigger, cause, and/or instruct the non-AP STA implemented by device 140 to receive the BSRP trigger frame, for example, according to the set periodicity, e.g., as described below.

In some demonstrative aspects, controller 154 may be configured to control, trigger, cause, and/or instruct the non-AP STA implemented by device 140 to process a management frame from the AP, for example, to identify an indication of a duration of a BSRP period, e.g., as described below.

In some demonstrative aspects, the BSRP period may include a time period between two consecutive low latency BSRP trigger frames including the predefined indication field set to the predefined setting to indicate the request to provide the current EDCA retry count, e.g., as described below.

In some demonstrative aspects, controller 154 may be configured to control, trigger, cause, and/or instruct the non-AP STA implemented by device 140 to receive the BSRP trigger frame, for example, according to the duration of the BSRP period, e.g., as described below.

In some demonstrative aspects, controller 154 may be configured to control, trigger, cause, and/or instruct the non-AP STA implemented by device 140 to process a broadcast TWT element from the AP, for example, to identify a broadcast TWT for one or more low latency non-AP STAs, e.g., as described below.

In some demonstrative aspects, the one or more low latency non-AP STAs may include the non-AP STA implemented by device 140.

In some demonstrative aspects, controller 154 may be configured to control, trigger, cause, and/or instruct the non-AP STA implemented by device 140 to receive the BSRP trigger frame including the predefined indication field set to the predefined setting to indicate the request to provide the current EDCA retry count for example, during a broadcast TWT SP of the broadcast TWT, e.g., as described below.

In some demonstrative aspects, controller 154 may be configured to control, trigger, cause, and/or instruct the non-AP STA implemented by device 140 to receive the BSRP trigger frame including the predefined indication field set to the predefined setting to indicate the request to provide the current EDCA retry count, for example, at a beginning of each broadcast TWT SP of the broadcast TWT, e.g., as described below.

In some demonstrative aspects, controller 154 may be configured to control, trigger, cause, and/or instruct the non-AP STA implemented by device 140 to process a predefined value in a broadcast TWT recommendation field of the broadcast TWT element, for example, to identify the broadcast TWT for the one or more low latency non-AP STAs, e.g., as described below.

In some demonstrative aspects, the predefined value may be 5. In other aspects, any other predetermined value may be utilized to identify the broadcast TWT for the one or more low latency non-AP STAs.

In some demonstrative aspects, controller 154 may be configured to control, trigger, cause, and/or instruct the non-AP STA implemented by device 140 to process low latency mode information from the AP, for example, to identify a low latency mode enablement indication to indicate enablement of a low latency mode at which the AP is to transmit low latency BSRP trigger frames including the predefined indication field set to the predefined setting to identify the broadcast TWT for the one or more low latency non-AP STAs, e.g., as described below.

In some demonstrative aspects, controller 154 may be configured to control, trigger, cause, and/or instruct the non-AP STA implemented by device 140 to process the low latency mode information, for example, to determine a low latency mode duration indication to indicate a time period during which the low latency mode is to be enabled, e.g., as described below.

In some demonstrative aspects, controller 154 may be configured to control, trigger, cause, and/or instruct the non-AP STA implemented by device 140 to process a low latency mode disablement indication from the AP, for example, to identify disablement of the low latency mode, e.g., as described below.

In some demonstrative aspects, device 102, device 140, and/or device 160 may be configured to implement one or more operations and/or functionalities of a BSR mechanism, which may be configured to utilize a BSRP trigger frame, which may include a field, which may be configured to indicate that a request for BSR feedback includes a request for information about a current EDCA retry count of a non-AP STA, e.g., as described below.

In some demonstrative aspects, it may be defined that the BSRP trigger frame may include a field, which may be configured to indicate that the request for BSR feedback includes a request for information about the current EDCA retry count of a non-AP STA, for example, for some TIDs that are considered as low latency TIDs which the non-AP STA will be reporting, e.g., as described below.

In some demonstrative aspects, the BSRP trigger frame may be configured to include a 1-bit field, e.g., a Low Latency Reporting field, which may be configured to indicate a request for the non-AP to provide the current EDCA retry count for the one or more low latency traffic flows, e.g., as described below.

In one example, the Low Latency Reporting field may be set to 1, for example, to indicate the request that the non-AP is to provide the current EDCA retry count.

In another example, the Low Latency Reporting field may be set to 0, for example, to indicate that there is no request for the non-AP to provide the current EDCA retry count.

In some demonstrative aspects, the BSRP trigger frame may be configured to include identification information, which may be configured to identify at least one low latency traffic flow, e.g., as described below.

In some demonstrative aspects, the BSRP trigger frame may include one or more fields, which may be configured to identify a TID and/or an SCSID of a low latency traffic flow that is requested by the AP.

In some demonstrative aspects, it may be defined that a non-AP STA, which receives from an AP a BSRP trigger frame with a request for a low latency feedback, may, e.g., shall, provide low latency feedback information, e.g., as described below.

In some demonstrative aspects, it may be defined that the non-AP STA, which receives from the AP the BSRP trigger frame with the request for the low latency feedback, may, e.g., shall, transmit to the AP a frame including a BSR, which may be configured to include the low latency feedback information for low latency traffic, e.g., as described below.

In some demonstrative aspects, it may be defined that, in response to the BSRP trigger frame from the AP, the non-AP STA is to transmit to the AP a frame including a solicited BSR, which includes one or more Aggregated Control (A-Control) fields, e.g., low latency A-Control fields, which may be configured to include the low latency feedback information, e.g., as described below.

In some demonstrative aspects, it may be defined that, in response to the BSRP trigger frame from the AP, the non-AP STA is to transmit to the AP a Multi-STA Block Acknowledgement (BA) frame including a BSR, which includes one or more fields configured to include the low latency feedback information.

In other aspects, it may be defined that, in response to the BSRP trigger frame from the AP, the non-AP STA is to transmit to the AP any other type of frame including the low latency feedback information in any other suitable field.

In some demonstrative aspects, it may be defined that, in response to the BSRP trigger frame from the AP, the non-AP STA is to transmit to the AP a frame including information corresponding to a reported low latency traffic flow, e.g., as described below.

In some demonstrative aspects, it may be defined that, in response to the BSRP trigger frame from the AP, the non-AP STA is to transmit to the AP a frame including an identification field including identification information to identify a reported low latency traffic flow.

In some demonstrative aspects, the identification field may include a TID field, which may be configured to include a low latency TID corresponding to the reported low latency traffic flow.

In some demonstrative aspects, it may be defined that the non-AP STA is to set the low latency TID in the frame to identify the reported low latency flow.

In some demonstrative aspects, the identification field may include an SCSID field, which may be configured to include an SCSID corresponding to the reported low latency flow.

In some demonstrative aspects it may be defined that the non-AP STA is to set the SCSID in the frame to identify the reported low latency flow.

In other aspects, non-AP STA may be configured to set any other information in the frame to identify the reported low latency flow.

In some demonstrative aspects, it may be defined that the non-AP STA is to set the frame to include a BSR field including a BSR corresponding to the reported low latency flow, e.g., which is identified by the TID.

In some demonstrative aspects, it may be defined that the non-AP STA is to set a current EDCA retry count field in the frame to include a current EDCA retry count corresponding to the reported low latency flow.

In some demonstrative aspects, the non-AP STA may be configured to set the current EDCA retry count including a current EDCA retry count value for an AC to which the TID and/or the SCSID are mapped to.

In some demonstrative aspects, it may be defined that the non-AP STA is to set the frame to include a backoff (BO) value for the AC to which the TID and/or the SCSID are mapped to.

In some demonstrative aspects, it may be defined that an AP is to process a received frame from the non-AP STA, for example, to identify the reported low latency flow, e.g., as described below.

In some demonstrative aspects, the AP may be configured process the received frame from the non-AP STA, for example, to identify the BSR corresponding to the reported low latency flow.

In some demonstrative aspects, the AP may be configured process the received frame from the non-AP STA, for example, to identify the current EDCA retry count corresponding to the reported low latency flow.

In some demonstrative aspects, the AP may consider that the non-AP STA is suffering from excess latency, for example, based on the current EDCA retry value corresponding to the reported low latency flow.

In some demonstrative aspects, the AP may be configured to decide to give an allocation to the non-AP STA, for example, in order for the non-AP STA to transmit one or more frames of the reported low latency flow, for example, based on a determination that the non-AP STA suffers from excess latency, e.g., as described below.

In some demonstrative aspects, the AP may be configured to send to the non-AP STA a basic trigger frame, for example, to schedule UL transmission, e.g., a TB PPDU, for example, for the non-AP STA to send low latency traffic.

In some demonstrative aspects, the AP may be configured to send to the non-AP STA a transmission (Tx) sharing(S) (TxS) Mode 1 MU-RTS frame, for example, to give the non-AP STA a time allocation to send to the AP the corresponding frames of the low latency traffic flow, for example, in a single user PPDU format.

In some demonstrative aspects, the non-AP STA may be configured to provide to the AP an actual channel access delay value, which the non-AP STA is experiencing for Head of Line packets, e.g., assuming it is capable of measuring this value.

For example, the on-AP STA may be configured to send to the AP a frame including an identification field including identification information to identify a reported low latency traffic flow, a BSR field including a BSR corresponding to the reported low latency traffic flow, a current EDCA retry count field including a current EDCA retry count corresponding to the reported low latency flow, and/or a channel access delay field including the actual channel access delay value corresponding to the low latency traffic flow.

In some demonstrative aspects, the AP may be configured to schedule BSRP trigger frames regularly, for example, every 20 milliseconds (ms) or at any other suitable periodicity, for example, to regularly poll one or more non-AP STAs with a BSRP trigger frame requesting for the EDCA retry count.

For example, the periodicity of polling the one or more non-AP STAs with the BSRP trigger frame requesting for the EDCA retry count may be configured to provide a technical solution to ensure that tail latency of the one or more non-AP STAs is to be maintained below a certain threshold, for example, below 20 ms.

For example, the periodicity of polling the one or more non-AP STAs with the BSRP trigger frame requesting for the EDCA retry count may be configured to provide a technical solution to maintain the tail latency of the one or more non-AP STAs below the threshold, for example, without having to rely on scheduling communications all the time, while letting the one or more non-AP STAs use an EDCA.

In some demonstrative aspects, the AP may be configured to transmit one or more management frames, for example, beacon frames and/or any other type of management frames, which may be configured to advertise that the AP is to schedule transmission of low latency BSRP trigger frames, e.g. including the request for the EDCA retry count, for example, according to a set periodicity.

In some demonstrative aspects, the AP may be configured to transmit one or more management frames, for example, beacon frames and/or any other type of management frames, an information element, which may be configured to indicate how frequently the AP is to poll the one or more non-AP STAs with the low latency BSRP trigger frames. For example, the periodicity may be every 5, 10, 20, 50 ms, or any other time period.

In some demonstrative aspects, the AP may be configured to configure the information element to include a list of the non-AP STAs that will be addressed by the BSRP trigger frames.

In some demonstrative aspects, the AP may be configured to configure the information element to include TIDs for which the EDCA retry count is to be requested by the BSRP trigger frames.

In other aspects, the information element may be configured to include any other additional or alternative information.

In some demonstrative aspects, the AP may be configured to transmit a broadcast TWT element, which may be configured to advertise a broadcast TWT for one or more non-AP STAs, for example, such that the one or more, e.g., all, non-AP STAs that the AP wants to aid with low latency traffic, are to become members of this broadcast TWT.

In some demonstrative aspects, the AP may be configured to schedule the low latency BSRP for transmission, for example, at a beginning of a broadcast TWT SP, e.g., each broadcast TWT SP. For example, the AP may configure the low latency BSRP to address one or more, e.g., all, non-AP STAs that are members of the broadcast TWT. For example, this mechanism may ensure that the non-AP STAs may know, e.g., approximately, when the AP is to try and schedule a non-AP STA for providing the low latency information.

In some demonstrative aspects, the AP may be configured to set a predefined value in a predefined field, e.g., a reserved field or a dedicated field, of the broadcast TWT element, for example, to qualify a broadcast TWT agreement as a low latency BSRP broadcast TWT agreement.

In one example, it may be defined that the AP is to set a value of 5 in a broadcast TWT recommendation field in the broadcast TWT element, for example, to indicate that a broadcast TWT agreement is to be defined as a low latency BSRP broadcast TWT agreement. In other aspects, any other value in the broadcast TWT recommendation field may be used to indicate that a broadcast TWT agreement is to be defined as a low latency BSRP broadcast TWT agreement.

In some demonstrative aspects, the broadcast TWT element may be configured to include one or more other additional or alternative fields, which may be configured to identify a broadcast TWT agreement as a low latency BSRP broadcast TWT agreement.

In some demonstrative aspects, the AP may be configured to transmit a low latency mode enablement indication, for example, to indicate enablement of a low latency mode, which may be utilized by the AP for transmission of the low latency BSRP trigger frames, e.g. including the request for the EDCA retry count.

In some demonstrative aspects, the AP may be configured to transmit a low latency mode disablement indication, for example, to signal that the AP is no longer supporting the low latency mode of operation.

In some demonstrative aspects, the AP may be configured to transmit one or more frames, which may be configured to signal a duration of time during which the low latency mode is to be active, and/or a duration of time during which the low latency mode is to be inactive.

In some demonstrative aspects, device 102, device 140, and/or device 160 may be configured to implement one or more operations and/or functionalities of an EDCA mechanism, which may be configured to support low latency traffic, e.g., as described below.

In some demonstrative aspects, device 102, device 140, and/or device 160 may be configured to implement one or more operations and/or functionalities of an EDCA mechanism, which may be configured to provide a technical solution for transitioning between a first EDCA setting, e.g., using regular EDCA parameters, and a second EDCA setting, e.g., using MU-EDCA parameters, e.g., as described below.

For example, the EDCA mechanism may be configured to implement one or more rules (also referred to as “EDCA transition rules”), which may be configured to define how a non-AP STA transitions between using regular EDCA parameters and using MU EDCA parameters, for example, in case both the regular EDCA parameters and the MU-EDCA parameters are advertised by an AP.

For example, it may be defined, e.g., according to the EDCA transition rules, that if the AP sends a trigger frame to the non-AP STA and the non-AP STA successfully transmits a data frame in an UL TB PPDU in response to the trigger frame with a TID corresponding to a particular AC, then the non-AP STA is to start using MU EDCA parameters, for example, a Minimum Contention Window (CW min), a Maximum Contention Window (CW max), and/or any other parameters, for the particular AC, and the non-AP STA is to initiate an MU EDCA timer, which may be configured to progressively decrement. For example, the non-AP STA may switch back to regular EDCA parameters, for example, if the MU EDCA timer reaches zero, while the non-AP STA is unable to send a data frame in a triggered mode with a TID corresponding to the particular AC.

In some demonstrative aspects, device 102, device 140, and/or device 160 may be configured to implement one or more operations and/or functionalities of an EDCA mechanism, which may be configured to support a Non-Primary Channel Access (NPCA) mechanism, e.g., as described below.

For example, the EDCA transition rules may be configured to support NPCA, e.g., as described below.

For example, an NPCA non-AP STA may include a non-AP STA, which supports the NPCA. For example, the non-AP STA may set to 1 an NPCA supported field in a capabilities information field of a UHR capabilities element transmitted by the non-AP STA, for example, to indicate that the non-AP STA is an NPCA non-AP STA.

For example, an NPCA AP may include an AP, which supports the NPCA. For example, the AP may set to 1 an NPCA supported field in a capabilities information field of a UHR capabilities element transmitted by the AP, for example, to indicate that the AP is an NPCA AP.

For example, it may be defined, e.g., according to the EDCA transition rules, that if the AP is using NPCA, and if the AP advertises MU EDCA parameters in the beacon frames the AP transmits, then an associated non-AP STA that is using NPCA and is subject to MU EDCA parameters rules is to apply the MU EDCA parameters rules considering all transmissions on a primary channel and on an NPCA primary channel.

For example, it may be defined, e.g., according to the EDCA transition rules, that the non-AP STA transitions from using regular EDCA parameters to using MU EDCA parameters for an AC, for example, if the AP sends a trigger frame to the non-AP STA and the non-AP STA successfully transmits a data frame in an UL TB PPDU in response to the trigger frame with a TID corresponding to the AC, for example, whether the transmission of the data frame is on a BSS primary channel or on the NPCA primary channel.

For example, it may be defined, e.g., according to the EDCA transition rules, that the non-AP STA is to maintain a single set of values, e.g., CW min, CW max, Arbitration Interframe Space Number (AIFSN), Contention Window (CW) values, and/or any other additional or alternative parameters, for both the BSS primary channel and the NPCA channel.

For example, it may be defined, e.g., according to the EDCA transition rules, that a single MU EDCA timer is to be set per non-AP STA per AC, and is to be applied equally to the BSS primary channel and the NPCA channel.

In some demonstrative aspects, device 102, device 140, and/or device 160 may be configured to implement one or more operations and/or functionalities of an EDCA mechanism, which may be configured to support a non-AP STA having low latency periodic traffic, e.g., as described below.

In some demonstrative aspects, device 102, device 140, and/or device 160 may be configured to implement one or more operations and/or functionalities of an EDCA mechanism, which may be configured to provide a technical solution to limit an MU EDCA timer, for example, to support a non-AP STA having low latency periodic traffic, e.g., as described below.

In some demonstrative aspects, the EDCA mechanism may be configured to provide a technical solution to limit the MU EDCA timer, for example, in case an AP is not triggering the non-AP STA enough, e.g., as described below.

In some demonstrative aspects, the EDCA mechanism may be configured to provide one or more exceptions, which may be configured to support the non-AP STA in using EDCA for low latency traffic, e.g., urgent traffic, e.g., as described below.

In some demonstrative aspects, controller 124 may be configured to control, trigger, cause, and/or instruct an AP implemented by device 102 to process information in a Stream Classification Service (SCS) request from a non-AP STA, for example, to identify a periodicity of a low latency traffic flow of the non-AP STA, e.g., as described below.

In some demonstrative aspects, controller 124 may be configured to control, trigger, cause, and/or instruct the AP implemented by device 102 to set an MU EDCA timer value in an MU EDCA timer field of an MU AC parameter record field, e.g., as described below.

In some demonstrative aspects, controller 124 may be configured to control, trigger, cause, and/or instruct the AP implemented by device 102 to set the MU EDCA timer value, for example, based on the periodicity of the low latency traffic flow of the non-AP STA, e.g., as described below.

In some demonstrative aspects, the MU EDCA timer value may be configured to indicate a duration of time during which the non-AP STA is to use a setting of one or more MU EDCA parameters, for example, according to the MU AC parameter record field, e.g., as described below.

In some demonstrative aspects, controller 124 may be configured to control, trigger, cause, and/or instruct the AP implemented by device 102 to transmit a beacon frame including an MU EDCA parameter set element, which includes the MU AC parameter record field, e.g., as described below.

In some demonstrative aspects, controller 124 may be configured to control, trigger, cause, and/or instruct the AP implemented by device 102 to set the MU EDCA timer value, for example, to indicate that the duration of time, during which the non-AP STA is to use a setting of one or more MU EDCA parameters, is to be no longer than a product of the periodicity of the low latency traffic flow of the non-AP STA multiplied by a predefined factor, e.g., as described below.

In some demonstrative aspects, controller 124 may be configured to control, trigger, cause, and/or instruct the AP implemented by device 102 to set the MU EDCA timer value, for example, to indicate that the duration of time, during which the non-AP STA is to use a setting of one or more MU EDCA parameters, is to be no longer than the periodicity of the low latency traffic flow of the non-AP STA, e.g., as described below.

In some demonstrative aspects, controller 124 may be configured to control, trigger, cause, and/or instruct the AP implemented by device 102 to set the MU EDCA timer value, for example, to indicate that the duration of time, during which the non-AP STA is to use a setting of one or more MU EDCA parameters, is to be no longer than half of the periodicity of the low latency traffic flow of the non-AP STA, e.g., as described below.

In some demonstrative aspects, controller 124 may be configured to control, trigger, cause, and/or instruct the AP implemented by device 102 to set the MU EDCA timer value, for example, to indicate that the duration of time, during which the non-AP STA is to use a setting of one or more MU EDCA parameters, is to be no longer than twice the periodicity of the low latency traffic flow of the non-AP STA, e.g., as described below.

In other aspects, controller 124 may be configured to control, trigger, cause, and/or instruct the AP implemented by device 102 to set the MU EDCA timer value to indicate any other duration based on the periodicity of the low latency traffic flow of the non-AP STA.

In some demonstrative aspects, controller 124 may be configured to control, trigger, cause, and/or instruct the AP implemented by device 102 to set an AC field in the MU AC parameter record field, for example, to identify an AC to which the low latency traffic flow of the non-AP STA is mapped, e.g., as described below.

In some demonstrative aspects, the setting of the one or more MU EDCA parameters according to the MU AC parameter record field may be configured, for example, for use by non-AP STAs following one or more particular UL MU High Efficiency (HE) Trigger Based (TB) Physical layer Protocol Data Unit (PPDU) transmissions, e.g., as described below.

In some demonstrative aspects, controller 154 may be configured to control, trigger, cause, and/or instruct a non-AP STA implemented by device 140 to transmit an SCS request to an AP, e.g., as described below.

In some demonstrative aspects, controller 154 may be configured to control, trigger, cause, and/or instruct the non-AP STA implemented by device 140 to transmit the SCS request including information to indicate a periodicity of a low latency traffic flow of the non-AP STA, e.g., as described below.

In some demonstrative aspects, controller 154 may be configured to control, trigger, cause, and/or instruct the non-AP STA implemented by device 140 to set an MU EDCA timer, for example, according to an MU EDCA timer value in an MU EDCA timer field of an MU AC parameter record field in an MU EDCA parameter set element of a beacon from the AP, e.g., as described below.

In some demonstrative aspects, the MU EDCA timer value may be configured to indicate a duration of time during which the non-AP STA is to use a setting of one or more MU EDCA parameters, for example, according to the MU AC parameter record field, e.g., as described below.

In some demonstrative aspects, controller 154 may be configured to allow the non-AP STA implemented by device 140 to use a regular EDCA parameter setting for UL transmission of the low latency traffic flow from the non-AP STA prior to expiration of the MU EDCA timer, for example, based on a determination that a trigger frame to trigger the UL transmission of the low latency traffic flow from the non-AP

STA has not been received from the AP according to the periodicity of the low latency traffic flow of the non-AP STA, e.g., as described below.

In some demonstrative aspects, controller 154 may be configured to allow the non-AP STA implemented by device 140 to operate according to a High Priority (HIP) EDCA for the UL transmission of the low latency traffic flow from the non-AP STA, for example, based on the determination that the trigger frame to trigger the UL transmission of the low latency traffic flow from the non-AP STA has not been received from the AP according to the periodicity of the low latency traffic flow of the non-AP STA, e.g., as described below.

In some demonstrative aspects, controller 154 may be configured to control, trigger, cause, and/or instruct the non-AP STA implemented by device 140 to process an AC field in the MU AC parameter record field, for example, to identify an AC to which the low latency traffic flow of the non-AP STA is mapped, e.g., as described below.

In some demonstrative aspects, the setting of the one or more MU EDCA parameters according to the MU AC parameter record field may be configured for use by non-AP STAs following one or more particular UL MU HE TB PPDU transmissions, e.g., as described below.

In some demonstrative aspects, device 102, device 140, and/or device 160 may be configured to implement one or more operations and/or functionalities of an EDCA mechanism, which may be configured to support low latency traffic, e.g., as described below.

In some demonstrative aspects, device 102, device 140, and/or device 160 may be configured to implement one or more operations and/or functionalities of an EDCA mechanism, which may be configured to support an AP in determining an MU EDCA timer, for example, based on latency constraints of a traffic flow of one or more non-AP STAs, e.g., as described below.

In some demonstrative aspects, it may be defined that, if an AP receives from an associated non-AP STA an SCS request describing, e.g., in a QoS characteristics element, a low latency traffic flow that has latency constraints and has a certain periodicity, e.g., 20 ms or any other periodicity, then the AP is to, e.g., shall, set an MU

EDCA timer, for example, based on the latency constraints indicated by the non-AP STA.

For example, it may be defined that, if the AP is advertising MU EDCA parameters in beacon frames it transmits, then the AP may, e.g., shall, set the MU EDCA timer to be no longer than a periodicity of the low latency traffic flow for an AC to which the low latency traffic flow is mapped.

In some demonstrative aspects, it may be defined that the AP may, e.g., shall, set the MU EDCA timer to be no longer than half of the periodicity of the low latency traffic flow.

In some demonstrative aspects, it may be defined that the AP may, e.g., shall, set the MU EDCA timer to be no longer than twice the periodicity of the low latency traffic flow.

In other aspects, it may be defined that the AP may, e.g., shall, set the MU EDCA timer according to any other multiple of the periodicity of the low latency traffic flow, and/or according to any other additional or alternative limitation and/or criterion defined based on the periodicity of the low latency traffic flow.

In some demonstrative aspects, it may be defined that a non-AP STA may be configured to use the MU EDCA parameters, for example, during a duration of time indicated by the MU EDCA timer.

In some demonstrative aspects, it may be defined that the non-AP STA may be allowed to compete for the channel using regular EDCA parameters, for example, once the MU EDCA timer expires.

In some demonstrative aspects, it may be defined that the non-AP STA having a low latency traffic flow may be allowed to use the regular EDCA setting, for example, if the MU EDCA timer advertised by the AP is longer than the periodicity of the low latency traffic flow.

In some demonstrative aspects, it may be defined that, in case the non-AP STA has not received from the AP a trigger frame to trigger UL transmission of the low latency traffic flow in time, then the non-AP STA may be, e.g., shall be, able to use regular EDCA parameters, e.g., for drawing a new BO with regular EDCA parameters, for example, in order to send packets for the low latency traffic flow, e.g., prior to expiration of the MU EDCA timer.

In some demonstrative aspects, it may be defined that, in case the non-AP STA has not received from the AP a trigger frame to trigger UL transmission of the low latency traffic flow in time, then the non-AP STA may, e.g., shall, become eligible to operate with HIP EDCA, e.g., to send a defer signal with a very high priority to reserve the medium to send the low latency traffic flow, for example, to be able to use regular EDCA, e.g., for drawing a new BO with regular EDCA parameters, for example, in order to send packets for the low latency traffic flow, e.g., prior to expiration of the MU EDCA timer.

In some demonstrative aspects, the AP may be configured to operate with NPCA, and may enable an operation mode during which untriggered transmissions from non-AP STAs are prohibited. For example, this operation mode may be similar to an MU EDCA parameter mode and/or any other relatively strict mode.

In some demonstrative aspects, it may be defined that, in case the non-AP STA has low latency traffic and the non-AP STA moved to an NPCA primary channel, then the non-AP STA may contend for a medium with regular EDCA parameters, e.g., the non-AP may have an exception.

For example, it may be defined that the low latency traffic may be identified by an SCS request transmitted from the non-AP STA to the AP, e.g., as described above.

In other aspects, the non-AP STA may be configured to transmit to the AP any other additional or alternative type of message, field, and/or information to identify one or more low latency traffic flows of the non-AP STA, and/or to provide periodicity information and/or any other type of information relating to the one or more low latency traffic flows of the non-AP STA.

For example, the low latency traffic of the non-AP STA may be identified by a high priority AC, e.g., an AC voice (AC_VO), and/or based on any other additional or alternative message and/or information.

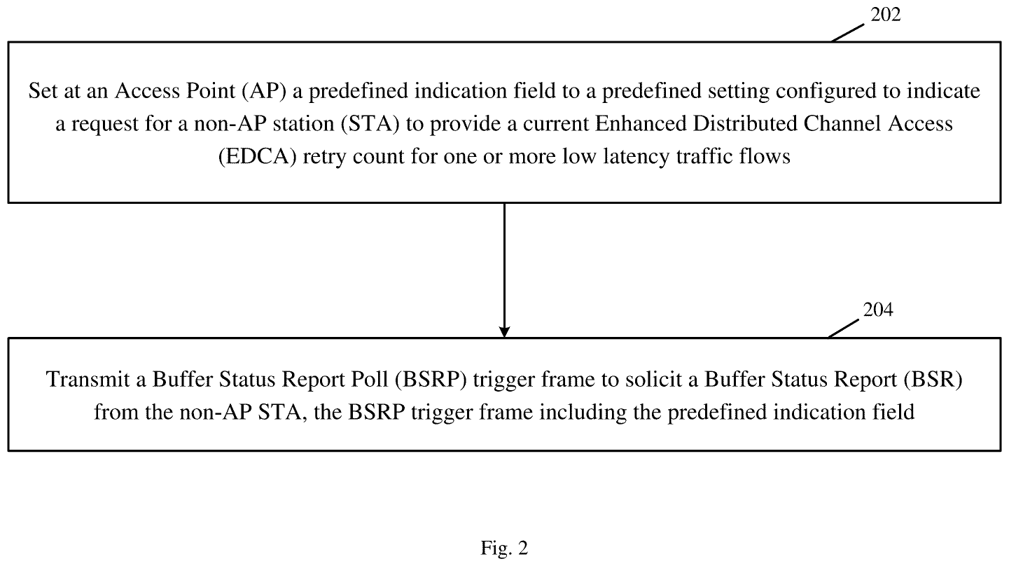

Reference is made to FIG. 2, which schematically illustrates a method of low latency traffic, in accordance with some demonstrative aspects. For example, one or more of the operations of the method of FIG. 2 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 202, the method may include setting at an AP a predefined indication field to a predefined setting configured to indicate a request for a non-AP STA to provide a current EDCA retry count for one or more low latency traffic flows. For example, controller 124 (FIG. 1) may be configured to cause, trigger, and/or control the AP implemented by device 102 (FIG. 1) to set a predefined indication field to a predefined setting configured to indicate a request for a non-AP STA implemented by device 140 (FIG. 1) to provide a current EDCA retry count for one or more low latency traffic flows, e.g., as described above.

As indicated at block 204, the method may include transmitting a BSRP trigger frame to solicit a BSR from the non-AP STA. For example, the BSRP trigger frame may be configured to include the predefined indication field. For example, controller 124 (FIG. 1) may be configured to cause, trigger, and/or control the AP implemented by device 102 (FIG. 1) to transmit a BSRP trigger frame to solicit a BSR from the non-AP STA implemented by device 140 (FIG. 1), the BSRP trigger frame including the predefined indication field to indicate the request for the non-AP STA to provide the current EDCA retry count, e.g., as described above.

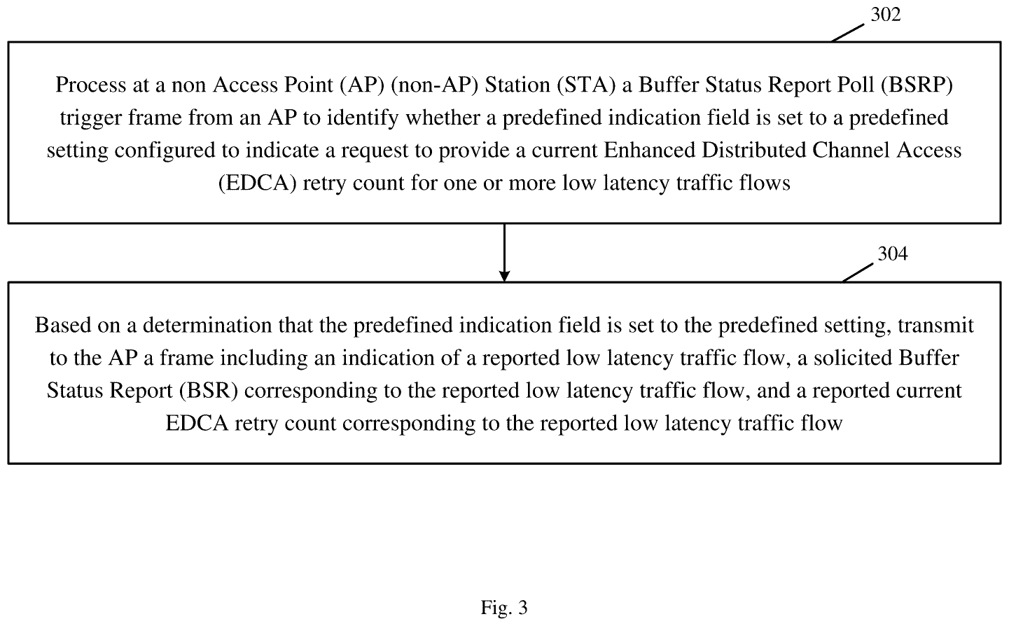

Reference is made to FIG. 3, which schematically illustrates a method of low latency traffic, in accordance with some demonstrative aspects. For example, one or more of the operations of the method of FIG. 3 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 302, the method may include processing at a non-AP STA a BSRP trigger frame from an AP, for example, to identify whether a predefined indication field is set to a predefined setting configured to indicate a request to provide a current EDCA retry count for one or more low latency traffic flows. For example, controller 154 (FIG. 1) may be configured to cause, trigger, and/or control the non-AP STA implemented by device 140 (FIG. 1) to process a BSRP trigger frame from the AP implemented by device 102 (FIG. 1), for example, to identify whether a predefined indication field is set to a predefined setting configured to indicate a request to provide a current EDCA retry count for one or more low latency traffic flows, e.g., as described above.

As indicated at block 304, the method may include transmitting to the AP a frame including an indication of a reported low latency traffic flow, a solicited BSR corresponding to the reported low latency traffic flow, and a reported current EDCA retry count corresponding to the reported low latency traffic flow, for example, based on a determination that the predefined indication field is set to the predefined setting. For example, controller 154 (FIG. 1) may be configured to cause, trigger, and/or control the non-AP STA implemented by device 140 (FIG. 1) to transmit to the AP implemented by device 102 (FIG. 1) a frame including an indication of a reported low latency traffic flow, a solicited BSR corresponding to the reported low latency traffic flow, and a reported current EDCA retry count corresponding to the reported low latency traffic flow, for example, based on a determination that the predefined indication field is set to the predefined setting, e.g., as described above.

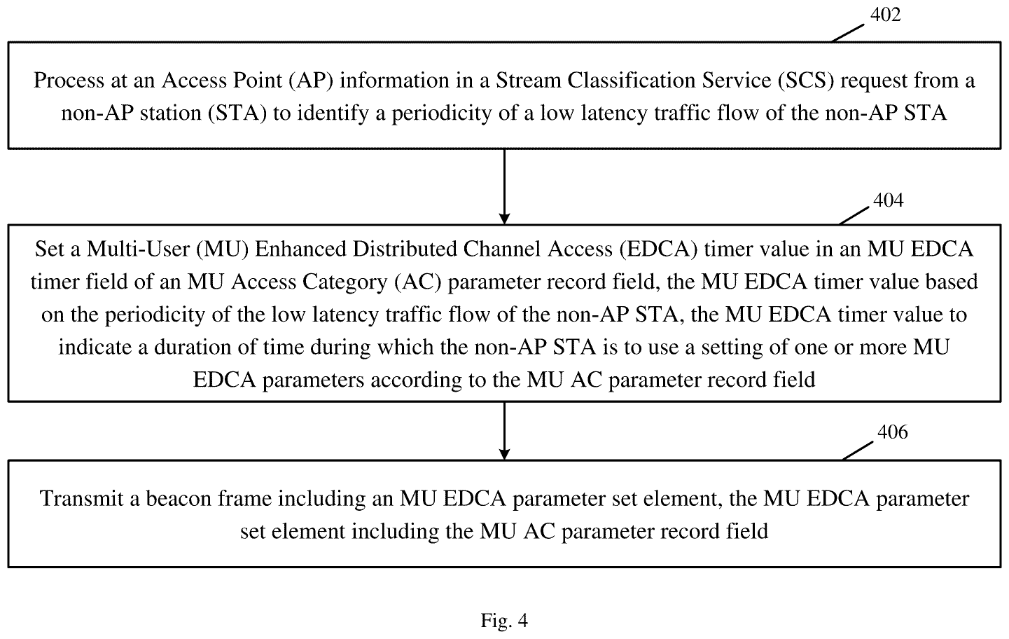

Reference is made to FIG. 4, which schematically illustrates a method of low latency traffic, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include processing at an AP information in a SCS request from a non-AP STA to identify a periodicity of a low latency traffic flow of the non-AP STA. For example, controller 124 (FIG. 1) may be configured to cause, trigger, and/or control the AP implemented by device 102 (FIG. 1) to process information in a SCS request from a non-AP STA implemented by device 140 (FIG. 1) to identify a periodicity of a low latency traffic flow of the non-AP STA, e.g., as described above.

As indicated at block 404, the method may include setting an MU EDCA timer value in an MU EDCA timer field of an MU AC parameter record field. For example, the MU EDCA timer value may be based on the periodicity of the low latency traffic flow of the non-AP STA. For example, the MU EDCA timer value may indicate a duration of time during which the non-AP STA is to use a setting of one or more MU EDCA parameters, for example, according to the MU AC parameter record field. For example, controller 124 (FIG. 1) may be configured to cause, trigger, and/or control the AP implemented by device 102 (FIG. 1) to set an MU EDCA timer value in an MU EDCA timer field of an MU AC parameter record field, e.g., as described above.

As indicated at block 406, the method may include transmitting a beacon frame including an MU EDCA parameter set element. For example, the MU EDCA parameter set element may include the MU AC parameter record field. For example, controller 124 (FIG. 1) may be configured to cause, trigger, and/or control the AP implemented by device 102 (FIG. 1) to transmit a beacon frame including an MU EDCA parameter set element, which includes the MU AC parameter record field, e.g., as described above.

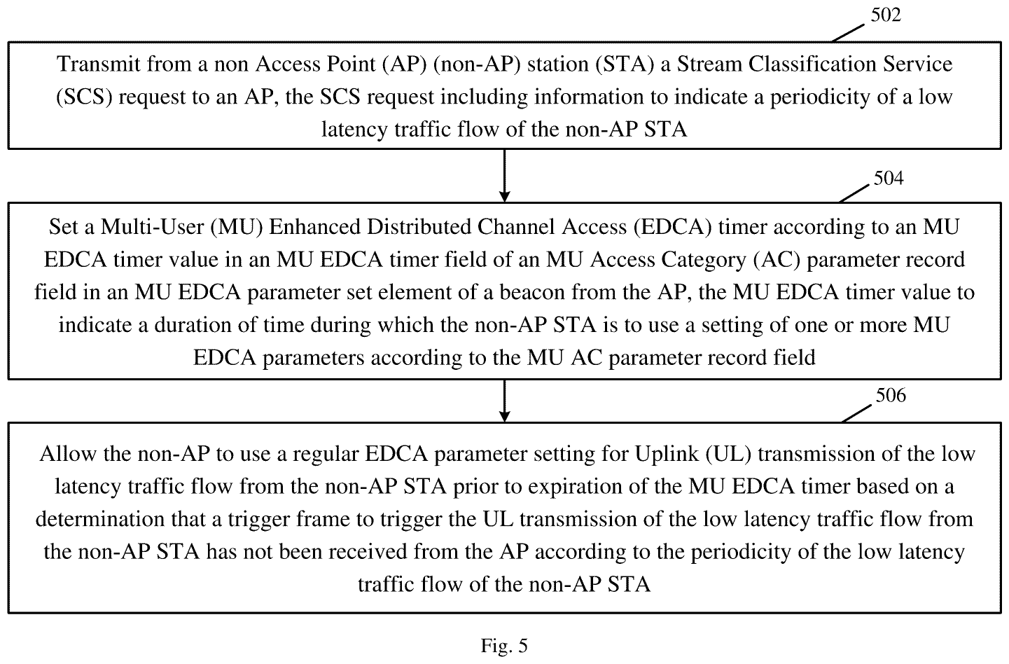

Reference is made to FIG. 5, which schematically illustrates a method of low latency traffic, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include transmitting from a non-AP STA an SCS request to an AP. For example, the SCS request may include information to indicate a periodicity of a low latency traffic flow of the non-AP STA. For example, controller 154 (FIG. 1) may be configured to cause, trigger, and/or control a non-AP STA implemented by device 140 (FIG. 1) to transmit to an AP an SCS request, which may include information to indicate a periodicity of a low latency traffic flow of the non-AP STA, e.g., as described above.

As indicated at block 504, the method may include setting an MU EDCA timer according to an MU EDCA timer value in an MU EDCA timer field of an MU AC parameter record field, which may be included, for example, in an MU EDCA parameter set element of a beacon from the AP. For example, the MU EDCA timer value may be configured to indicate a duration of time during which the non-AP STA is to use a setting of one or more MU EDCA parameters, for example, according to the MU AC parameter record field. For example, controller 154 (FIG. 1) may be configured to cause, trigger, and/or control the non-AP STA implemented by device 140 (FIG. 1) to set an MU EDCA timer according to an MU EDCA timer value in an MU EDCA timer field of an MU AC parameter record field in an MU EDCA parameter set element of a beacon from the AP, e.g., as described above.

As indicated at block 506, the method may include allowing the non-AP STA to use a regular EDCA parameter setting for UL transmission of the low latency traffic flow from the non-AP STA prior to expiration of the MU EDCA timer, for example, based on a determination that a trigger frame to trigger the UL transmission of the low latency traffic flow from the non-AP STA has not been received from the AP according to the periodicity of the low latency traffic flow of the non-AP STA. For example, controller 154 (FIG. 1) may be configured to cause, trigger, and/or control the non-AP STA implemented by device 140 (FIG. 1) to allow the non-AP to use a regular EDCA parameter setting for UL transmission of the low latency traffic flow from the non-AP STA prior to expiration of the MU EDCA timer, for example, based on a determination that a trigger frame to trigger the UL transmission of the low latency traffic flow from the non-AP STA has not been received from the AP according to the periodicity of the low latency traffic flow of the non-AP STA, e.g., as described above.

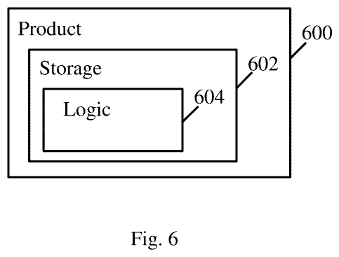

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a processor configured to cause an Access Point (AP) to set a predefined indication field to a predefined setting configured to indicate a request for a non-AP station (STA) to provide a current Enhanced Distributed Channel Access (EDCA) retry count for one or more low latency traffic flows; and transmit a Buffer Status Report Poll (BSRP) trigger frame to solicit a Buffer Status Report (BSR) from the non-AP STA, the BSRP trigger frame comprising the predefined indication field; and a memory to store information processed by the processor.

Example 2 includes the subject matter of Example 1, and optionally, wherein the apparatus is configured to cause the AP to set a single bit in the predefined indication field to a predefined value to indicate the request for the non-AP to provide the current EDCA retry count for the one or more low latency traffic flows.

Example 3 includes the subject matter of Example 2, and optionally, wherein the predefined value is one.

Example 4 includes the subject matter of any one of Examples 1-3, and optionally, wherein the apparatus is configured to cause the AP to set identification information in the predefined indication field, the identification information configured to identify at least one low latency traffic flow.

Example 5 includes the subject matter of Example 4, and optionally, wherein the identification information comprises at least one of a low latency Traffic Identifier (TID) corresponding to the at least one low latency traffic flow, or a Stream Classification Service Identifier (SCSID) corresponding to the at least one low latency traffic flow.

Example 6 includes the subject matter of any one of Examples 1-5, and optionally, wherein the predefined indication field comprises a low latency reporting field in the BSRP trigger frame.

Example 7 includes the subject matter of any one of Examples 1-6, and optionally, wherein the apparatus is configured to cause the AP to process a received frame from the non-AP STA to identify a reported low latency traffic flow, a solicited BSR corresponding to the reported low latency traffic flow, and a reported current EDCA retry count corresponding to the reported low latency traffic flow.

Example 8 includes the subject matter of Example 7, and optionally, wherein the apparatus is configured to cause the AP to allocate Uplink (UL) resources for the non-AP STA based on the reported current EDCA retry count.

Example 9 includes the subject matter of Example 8, and optionally, wherein the apparatus is configured to cause the AP to transmit a trigger frame to trigger an UL transmission from the non-AP STA according to the UL resources allocated for the non-AP STA.

Example 10 includes the subject matter of Example 8 or 9, and optionally, wherein the apparatus is configured to cause the AP to transmit a Multi-User Request to Send (MU-RTS) frame to configure a time allocation for the non-AP STA according to the UL resources allocated for the non-AP STA.

Example 11 includes the subject matter of any one of Examples 7-10, and optionally, wherein the reported current EDCA retry count comprises a current EDCA retry count value for an Access Category (AC) to which the low latency traffic flow is mapped.

Example 12 includes the subject matter of any one of Examples 7-11, and optionally, wherein the apparatus is configured to cause the AP to identify the reported low latency traffic flow based on a low latency Traffic Identifier (TID) or a Stream Classification Service Identifier (SCSID) in the received frame.

Example 13 includes the subject matter of any one of Examples 1-12, and optionally, wherein the apparatus is configured to cause the AP to transmit a management frame configured to advertise that the AP is to schedule transmission of low latency BSRP trigger frames according to a set periodicity, the low latency BSRP trigger frames comprising the predefined indication field set to the predefined setting.

Example 14 includes the subject matter of any one of Examples 1-13, and optionally, wherein the apparatus is configured to cause the AP to transmit a management frame configured to indicate a duration of a BSRP period, the BSRP period comprising a time period between two consecutive low latency BSRP trigger frames comprising the predefined indication field set to the predefined setting.

Example 15 includes the subject matter of any one of Examples 1-14, and optionally, wherein the apparatus is configured to cause the AP to transmit a broadcast Target Wake Time (TWT) element configured to advertise a broadcast TWT for one or more low latency non-AP STAs, the one or more low latency non-AP STAs comprising the non-AP STA; and transmit the BSRP trigger frame comprising the predefined indication field set to the predefined setting during a broadcast TWT Service Period (SP) of the broadcast TWT.

Example 16 includes the subject matter of Example 15, and optionally, wherein the apparatus is configured to cause the AP to transmit the BSRP trigger frame comprising the predefined indication field set to the predefined setting at a beginning of each broadcast TWT SP of the broadcast TWT.

Example 17 includes the subject matter of Example 15 or 16, and optionally, wherein the apparatus is configured to cause the AP to set a predefined value in a broadcast TWT recommendation field of the broadcast TWT element to advertise the broadcast TWT for the one or more low latency non-AP STAs.

Example 18 includes the subject matter of Example 17, and optionally, wherein the predefined value is 5.

Example 19 includes the subject matter of any one of Examples 1-18, and optionally, wherein the apparatus is configured to cause the AP to transmit low latency mode information comprising a low latency mode enablement indication to indicate enablement of a low latency mode at which the AP is to transmit low latency BSRP trigger frames comprising the predefined indication field set to the predefined setting.

Example 20 includes the subject matter of Example 19, and optionally, wherein the apparatus is configured to cause the AP to configure the low latency mode information comprising a low latency mode duration indication to indicate a time period during which the low latency mode is to be enabled.

Example 21 includes the subject matter of Example 19 or 20, and optionally, wherein the apparatus is configured to cause the AP to transmit a low latency mode disablement indication to indicate disablement of the low latency mode.

Example 22 includes the subject matter of any one of Examples 1-21, and optionally, comprising a radio to transmit the BSRP trigger frame from the AP.

Example 23 includes the subject matter of Example 22, and optionally, comprising one or more antennas connected to the radio, and another processor to execute instructions of an operating system.

Example 24 includes an apparatus comprising a processor configured to cause a non Access Point (AP) (non-AP) station (STA) to process a Buffer Status Report Poll (BSRP) trigger frame from an AP to identify whether a predefined indication field is set to a predefined setting configured to indicate a request to provide a current Enhanced Distributed Channel Access (EDCA) retry count for one or more low latency traffic flows; and based on a determination that the predefined indication field is set to the predefined setting, transmit to the AP a frame comprising an indication of a reported low latency traffic flow, a solicited Buffer Status Report (BSR) corresponding to the reported low latency traffic flow, and a reported current EDCA retry count corresponding to the reported low latency traffic flow; and a memory to store information processed by the processor.

Example 25 includes the subject matter of Example 24, and optionally, wherein the apparatus is configured to cause the non-AP STA to determine that the predefined indication field is set to the predefined setting based on a determination that a single bit in the predefined indication field is set to a predefined value.

Example 26 includes the subject matter of Example 25, and optionally, wherein the predefined value is one.

Example 27 includes the subject matter of any one of Examples 24-26, and optionally, wherein the apparatus is configured to cause the non-AP STA to process identification information in the predefined indication field to identify at least one low latency traffic flow.

Example 28 includes the subject matter of Example 27, and optionally, wherein the identification information comprises at least one of a low latency Traffic Identifier (TID) corresponding to the at least one low latency traffic flow, or a Stream Classification Service Identifier (SCSID) corresponding to the at least one low latency traffic flow.

Example 29 includes the subject matter of any one of Examples 24-28, and optionally, wherein the predefined indication field comprises a low latency reporting field in the BSRP trigger frame.

Example 30 includes the subject matter of any one of Examples 24-29, and optionally, wherein the apparatus is configured to cause the non-AP STA to set the reported current EDCA retry count comprising a current EDCA retry count value for an Access Category (AC) to which the low latency traffic flow is mapped.

Example 31 includes the subject matter of any one of Examples 24-30, and optionally, wherein the apparatus is configured to cause the non-AP STA to set a low latency Traffic Identifier (TID) or a Stream Classification Service Identifier (SCSID) in the frame to identify the reported low latency traffic flow.

Example 32 includes the subject matter of any one of Examples 24-31, and optionally, wherein the apparatus is configured to cause the non-AP STA to process a management frame from the AP to identify an indication that the AP is to schedule transmission of low latency BSRP trigger frames according to a set periodicity, the low latency BSRP trigger frames comprising the predefined indication field set to the predefined setting; and receive the BSRP trigger frame according to the set periodicity.

Example 33 includes the subject matter of any one of Examples 24-32, and optionally, wherein the apparatus is configured to cause the non-AP STA to process a management frame from the AP to identify an indication of a duration of a BSRP period, the BSRP period comprising a time period between two consecutive low latency BSRP trigger frames comprising the predefined indication field set to the predefined setting; and receive the BSRP trigger frame according to the duration of the BSRP period.

Example 34 includes the subject matter of any one of Examples 24-33, and optionally, wherein the apparatus is configured to cause the non-AP STA to process a broadcast Target Wake Time (TWT) element from the AP to identify a broadcast TWT for one or more low latency non-AP STAs, the one or more low latency non-AP STAs comprising the non-AP STA; and receive the BSRP trigger frame comprising the predefined indication field set to the predefined setting during a broadcast TWT Service Period (SP) of the broadcast TWT.

Example 35 includes the subject matter of Example 34, and optionally, wherein the apparatus is configured to cause the non-AP STA to receive the BSRP trigger frame comprising the predefined indication field set to the predefined setting at a beginning of each broadcast TWT SP of the broadcast TWT.

Example 36 includes the subject matter of Example 34 or 35, and optionally, wherein the apparatus is configured to cause the non-AP STA to process a predefined value in a broadcast TWT recommendation field of the broadcast TWT element to identify the broadcast TWT for the one or more low latency non-AP STAs.

Example 37 includes the subject matter of Example 36, and optionally, wherein the predefined value is 5.

Example 38 includes the subject matter of any one of Examples 24-36, and optionally, wherein the apparatus is configured to cause the non-AP STA to process low latency mode information from the AP to identify a low latency mode enablement indication to indicate enablement of a low latency mode at which the AP is to transmit low latency BSRP trigger frames comprising the predefined indication field set to the predefined setting.

Example 39 includes the subject matter of Example 38, and optionally, wherein the apparatus is configured to cause the non-AP STA to process the low latency mode information to determine a low latency mode duration indication to indicate a time period during which the low latency mode is to be enabled.

Example 40 includes the subject matter of Example 38 or 39, and optionally, wherein the apparatus is configured to cause the non-AP STA to process a low latency mode disablement indication from the AP to identify disablement of the low latency mode.

Example 41 includes the subject matter of any one of Examples 24-40, and optionally, comprising a radio to receive the BSRP trigger frame from the AP, and to transmit the frame to the AP.

Example 42 includes the subject matter of Example 41, and optionally, comprising one or more antennas connected to the radio, and another processor to execute instructions of an operating system.

Example 43 includes an apparatus comprising a processor configured to cause an Access Point (AP) to process information in a Stream Classification Service (SCS) request from a non-AP STA to identify a periodicity of a low latency traffic flow of the non-AP STA; set a Multi-User (MU) Enhanced Distributed Channel Access (EDCA) timer value in a MU EDCA timer field of a MU Access Category (AC) parameter record field, the MU EDCA timer value based on the periodicity of the low latency traffic flow of the non-AP STA, the MU EDCA timer value to indicate a duration of time during which the non-AP STA is to use a setting of one or more MU EDCA parameters according to the MU AC parameter record field; and transmit a beacon frame comprising an MU EDCA parameter set element, the MU EDCA parameter set element comprising the MU AC parameter record field; and a memory to store information processed by the processor.

Example 44 includes the subject matter of Example 43, and optionally, wherein the apparatus is configured to cause the AP to set the MU EDCA timer value to indicate that the duration of time is to be no longer than a product of the periodicity of the low latency traffic flow of the non-AP STA multiplied by a predefined factor.

Example 45 includes the subject matter of Example 43, and optionally, wherein the apparatus is configured to cause the AP to set the MU EDCA timer value to indicate that the duration of time is to be no longer than the periodicity of the low latency traffic flow of the non-AP STA.

Example 46 includes the subject matter of Example 43, and optionally, wherein the apparatus is configured to cause the AP to set the MU EDCA timer value to indicate that the duration of time is to be no longer than half of the periodicity of the low latency traffic flow of the non-AP STA.

Example 47 includes the subject matter of Example 43, and optionally, wherein the apparatus is configured to cause the AP to set the MU EDCA timer value to indicate that the duration of time is to be no longer than twice the periodicity of the low latency traffic flow of the non-AP STA.

Example 48 includes the subject matter of any one of Examples 43-47, and optionally, wherein the apparatus is configured to cause the AP to set an AC field in the MU AC parameter record field to identify an AC to which the low latency traffic flow of the non-AP STA is mapped.

Example 49 includes the subject matter of any one of Examples 43-48, and optionally, wherein the setting of the one or more MU EDCA parameters according to the MU AC parameter record field is configured for use by non-AP STAs following one or more particular Uplink (UL) MU High Efficiency (HE) Trigger Based (TB) Physical layer Protocol Data Unit (PPDU) transmissions.

Example 50 includes the subject matter of any one of Examples 43-49, and optionally, comprising a radio to transmit the beacon frame from the AP.

Example 51 includes the subject matter of Example 50, and optionally, comprising one or more antennas connected to the radio, and another processor to execute instructions of an operating system.

Example 52 includes an apparatus comprising a processor configured to cause a non Access Point (AP) (non-AP) station (STA) to transmit a Stream Classification Service (SCS) request to an AP, the SCS request comprising information to indicate a periodicity of a low latency traffic flow of the non-AP STA; set a Multi-User (MU) Enhanced Distributed Channel Access (EDCA) timer according to an MU EDCA timer value in an MU EDCA timer field of a MU Access Category (AC) parameter record field in an MU EDCA parameter set element of a beacon from the AP, the MU EDCA timer value to indicate a duration of time during which the non-AP STA is to use a setting of one or more MU EDCA parameters according to the MU AC parameter record field; and based on a determination that a trigger frame to trigger Uplink (UL) transmission of the low latency traffic flow from the non-AP STA has not been received from the AP according to the periodicity of the low latency traffic flow of the non-AP STA, allow the non-AP STA to use a regular EDCA parameter setting for the UL transmission of the low latency traffic flow from the non-AP STA prior to expiration of the MU EDCA timer; and a memory to store information processed by the processor.

Example 53 includes the subject matter of Example 52, and optionally, wherein the apparatus is configured to allow the AP to operate according to a High Priority (HIP) EDCA for the UL transmission of the low latency traffic flow from the non-AP STA based on the determination that the trigger frame to trigger the UL transmission of the low latency traffic flow from the non-AP STA has not been received from the AP according to the periodicity of the low latency traffic flow of the non-AP STA.

Example 54 includes the subject matter of Example 52 or 53, and optionally, wherein the apparatus is configured to cause the non-AP STA to process an AC field in the MU AC parameter record field to identify an AC to which the low latency traffic flow of the non-AP STA is mapped.

Example 55 includes the subject matter of any one of Examples 52-54, and optionally, wherein the setting of the one or more MU EDCA parameters according to the MU AC parameter record field is configured for use by non-AP STAs following one or more particular Uplink (UL) MU High Efficiency (HE) Trigger Based (TB) Physical layer Protocol Data Unit (PPDU) transmissions.

Example 56 includes the subject matter of any one of Examples 52-55, and optionally, comprising a radio to transmit the SCS request to the AP, receive the beacon frame from the AP, and transmit the UL transmission to the AP.

Example 57 includes the subject matter of Example 56, and optionally, comprising one or more antennas connected to the radio, and another processor to execute instructions of an operating system.

Example 58 includes a wireless communication device comprising the apparatus of any of Examples 1-57.

Example 59 includes a mobile device comprising the apparatus of any of Examples 1-57.

Example 60 includes an apparatus comprising means for executing any of the described operations of any of Examples 1-57.

Example 61 includes a product comprising one or more tangible computer-readable non-transitory storage media comprising instructions operable to, when executed by at least one processor, enable the at least one processor to cause any of the described operations of any of Examples 1-57.

Example 62 includes an apparatus comprising: a memory interface; and processing circuitry configured to: perform any of the described operations of any of Examples 1-57.

Example 63 includes a method comprising any of the described operations of any of Examples 1-53.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to cause an Access Point (AP) to:
set a predefined indication field to a predefined setting configured to indicate a request for a non-AP station (STA) to provide a current Enhanced Distributed Channel Access (EDCA) retry count for one or more low latency traffic flows; and
transmit a Buffer Status Report Poll (BSRP) trigger frame to solicit a Buffer Status Report (BSR) from the non-AP STA, the BSRP trigger frame comprising the predefined indication field; and
a memory to store information processed by the processor.

2. The apparatus of claim 1 configured to cause the AP to set a single bit in the predefined indication field to a predefined value to indicate the request for the non-AP to provide the current EDCA retry count for the one or more low latency traffic flows.

3. The apparatus of claim 1 configured to cause the AP to set identification information in the predefined indication field, the identification information configured to identify at least one low latency traffic flow.

4. The apparatus of claim 3, wherein the identification information comprises at least one of a low latency Traffic Identifier (TID) corresponding to the at least one low latency traffic flow, or a Stream Classification Service Identifier (SCSID) corresponding to the at least one low latency traffic flow.

5. The apparatus of claim 1, wherein the predefined indication field comprises a low latency reporting field in the BSRP trigger frame.

6. The apparatus of claim 1 configured to cause the AP to process a received frame from the non-AP STA to identify a reported low latency traffic flow, a solicited BSR corresponding to the reported low latency traffic flow, and a reported current EDCA retry count corresponding to the reported low latency traffic flow.

7. The apparatus of claim 6 configured to cause the AP to allocate Uplink (UL) resources for the non-AP STA based on the reported current EDCA retry count.

8. The apparatus of claim 6, wherein the reported current EDCA retry count comprises a current EDCA retry count value for an Access Category (AC) to which the low latency traffic flow is mapped.

9. The apparatus of claim 6 configured to cause the AP to identify the reported low latency traffic flow based on a low latency Traffic Identifier (TID) or a Stream Classification Service Identifier (SCSID) in the received frame.

10. The apparatus of claim 1 configured to cause the AP to transmit a management frame configured to advertise that the AP is to schedule transmission of low latency BSRP trigger frames according to a set periodicity, the low latency BSRP trigger frames comprising the predefined indication field set to the predefined setting.

11. The apparatus of claim 1 configured to cause the AP to transmit a management frame configured to indicate a duration of a BSRP period, the BSRP period comprising a time period between two consecutive low latency BSRP trigger frames comprising the predefined indication field set to the predefined setting.

12. The apparatus of claim 1 configured to cause the AP to:
transmit a broadcast Target Wake Time (TWT) element configured to advertise a broadcast TWT for one or more low latency non-AP STAs, the one or more low latency non-AP STAs comprising the non-AP STA; and
transmit the BSRP trigger frame comprising the predefined indication field set to the predefined setting during a broadcast TWT Service Period (SP) of the broadcast TWT.

13. The apparatus of claim 12 configured to cause the AP to transmit the BSRP trigger frame comprising the predefined indication field set to the predefined setting at a beginning of each broadcast TWT SP of the broadcast TWT.

14. The apparatus of claim 12 configured to cause the AP to set a predefined value in a broadcast TWT recommendation field of the broadcast TWT element to advertise the broadcast TWT for the one or more low latency non-AP STAs.

15. The apparatus of claim 14, wherein the predefined value is 5.

16. The apparatus of claim 1 configured to cause the AP to transmit low latency mode information comprising a low latency mode enablement indication to indicate enablement of a low latency mode at which the AP is to transmit low latency BSRP trigger frames comprising the predefined indication field set to the predefined setting.

17. The apparatus of claim 16 configured to cause the AP to transmit a low latency mode disablement indication to indicate disablement of the low latency mode.

18. The apparatus of claim 1 comprising a radio to transmit the BSRP trigger frame from the AP, one or more antennas connected to the radio, and another processor to execute instructions of an operating system.

19. An apparatus comprising:
a processor configured to cause a non Access Point (AP) (non-AP) station (STA) to:
process a Buffer Status Report Poll (BSRP) trigger frame from an AP to identify whether a predefined indication field is set to a predefined setting configured to indicate a request to provide a current Enhanced Distributed Channel Access (EDCA) retry count for one or more low latency traffic flows; and
based on a determination that the predefined indication field is set to the predefined setting, transmit to the AP a frame comprising an indication of a reported low latency traffic flow, a solicited Buffer Status Report (BSR) corresponding to the reported low latency traffic flow, and a reported current EDCA retry count corresponding to the reported low latency traffic flow; and
a memory to store information processed by the processor.

20. The apparatus of claim 19 configured to cause the non-AP STA to set the reported current EDCA retry count comprising a current EDCA retry count value for an Access Category (AC) to which the low latency traffic flow is mapped.
